(19) United States
(12) Patent Application Publication
(10) Pub. No.: US 2016/0218475 A1
(43) Pub. Date: Jul. 28, 2016

(54) Connector Installation and Removal Tool

(71) Applicant: HANLONG INDUSTRIAL CO., LTD., New Taipei City (TW)

(72) Inventors: Chien-Chou Liao, New Taipei City (TW); Hsing-Chieh Ho, New Taipei City (TW); Wan-Chi Huang, New Taipei City (TW)

(21) Appl. No.: 14/664,980

(22) Filed: Mar. 23, 2015

(30) Foreign Application Priority Data
Jan. 27, 2015 (TW) 104201268

(51) Int. Cl. H01R 43/20; H01R 43/28

(52) U.S. Cl. CPC H01R 43/20; H01R 43/28

(57) ABSTRACT

A connector installation and removal tool includes an assembly rod and a grip. The assembly rod includes a first end, a second end, a first assembly part and a second assembly part. The first assembly part is located on the first end. The second assembly part is located on the second end. The grip includes a groove and a fastening structure. The fastening structure is located in the groove, and the fastening structure is used for fastening to the first assembly part or the second assembly part.

### BACKGROUND OF THE INVENTION

1. Field of the Invention

The present invention relates to a connector installation and removal tool; more particularly, the present invention relates to a connector installation and removal tool for installing connectors of different specifications.

2. Description of the Related Art

Common electronic devices with audio and video signal transmission functions (such as the television or the telephone) usually need to work with a signal wire which can transfer the audio and video signal to an external signal source. The signal wire has a wire body and a connector. The wire body is used for electrically connecting to the external signal source. The connector has a thread structure, and the thread structure is used for fastening to the electronic device with the audio and video signal transmission function such that the signal wire can be fastened to the electronic device stably to transfer the audio and video signals to the electronic device. Generally, the assembly personnel use their fingers to directly rotate the connector to fasten the thread structure of the connector to the electronic device. However, if the fingers are used to rotate the connector for a long time, the personnel may suffer discomfort or injury. Therefore, assembly personnel may use a connector installation tool to easily fasten the connector to the electronic device without using the fingers directly.

The common connector installation tool has a fastening clip and a grip. The fastening clip is used for fastening to the connector, and the grip is provided for the assembly personnel to hold, whereby the assembly personnel can use the fastening clip to fasten the connector and rotate the grip to fasten the connector to the electronic device via the thread structure. However, different connectors have different sizes and different shapes, so the different connectors must be connected with connector installation tools of different specifications. Therefore, the assembly personnel must buy many connector installation tools of different specifications to install connectors of different sizes and shapes; however, purchasing many connector installation tools of different specifications entails high costs, and storing and transporting many connector installation tools require a certain amount of space and can be difficult to carry, causing inconvenience to the user.

Therefore, there is a need to provide a new connector installation tool for installing connectors of different specifications.

### SUMMARY OF THE INVENTION

It is an object of the present invention to provide a connector installation and removal tool for installing connectors of different specifications.

To achieve the abovementioned object, the connector installation and removal tool of the present invention includes an assembly rod and a grip. The assembly rod includes a first end, a second end, a first assembly part and a second assembly part. The first assembly part is located on the first end. The second assembly part is located on the second end. The grip includes a groove and a fastening structure. The fastening structure is located in the groove, and the fastening structure is used for fastening to the first assembly part or the second assembly part.

According to one embodiment of the present invention, the assembly rod further includes a rod body, and the fastening structure further includes a first fastening part and a second fastening part. The first fastening part and the second fastening part are used for fastening to the rod body.

According to one embodiment of the present invention, the fastening structure further includes a fastening surface, and the fastening surface is used for fastening the first assembly part or the second assembly part to the fastening structure.

According to one embodiment of the present invention, the connector installation and removal tool further includes a wire extending unit, and the wire extending unit is connected to the grip.

According to one embodiment of the present invention, the connector installation and removal tool further includes a connector fastening unit, and the connector fastening unit is connected to the grip.

According to one embodiment of the present invention, the first assembly part further includes a first connector fastening surface and a first opening. The first connector fastening surface is connected to the first opening.

According to one embodiment of the present invention, the first connector fastening surface is an arc-type structure.

According to one embodiment of the present invention, the second assembly part further includes a second connector fastening surface and a second opening. The second connector fastening surface is connected to the second opening.

According to one embodiment of the present invention, the second connector fastening surface is a multilateral structure.

### BRIEF DESCRIPTION OF THE DRAWINGS

FIG. 1 illustrates an exploded view of the connector installation and removal tool in one embodiment of the present invention.

FIG. 2 illustrates a schematic drawing of the connector installation and removal tool when the second assembly part and the fastening structure are fastened to each other in one embodiment of the present invention.

FIG. 3 illustrates a schematic drawing of the connector installation and removal tool when the first assembly part and the fastening structure are fastened to each other in one embodiment of the present invention.

FIG. 4 illustrates a sectional view of the connector installation and removal tool in one embodiment of the present invention along the hatch line AA shown in FIG. 2.

FIG. 5 illustrates a sectional view of the grip in one embodiment of the present invention along the hatch line BB shown in FIG. 4.

FIG. 6 illustrates a sectional view of the fastening structure of the grip when fastened to the first assembly part in one embodiment of the present invention along the hatch line BB shown in FIG. 4.

FIG. 7 illustrates a schematic drawing of the connector installation and removal tool, the connector and the wire in one embodiment of the present invention.

FIG. 8 illustrates a schematic drawing of the first assembly part of the connector installation and removal tool when fastening to the connector in one embodiment of the present invention.

FIG. 9 illustrates a schematic drawing of the second assembly part of the connector installation and removal tool when fastening to the connector in one embodiment of the present invention.

FIG. 10 illustrates a schematic drawing of the wire extending unit in one embodiment of the present invention.

FIG. 11 illustrates another schematic drawing of the wire extending unit in one embodiment of the present invention.

FIG. 12 illustrates a schematic drawing of the connector fastening unit and the wire in one embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

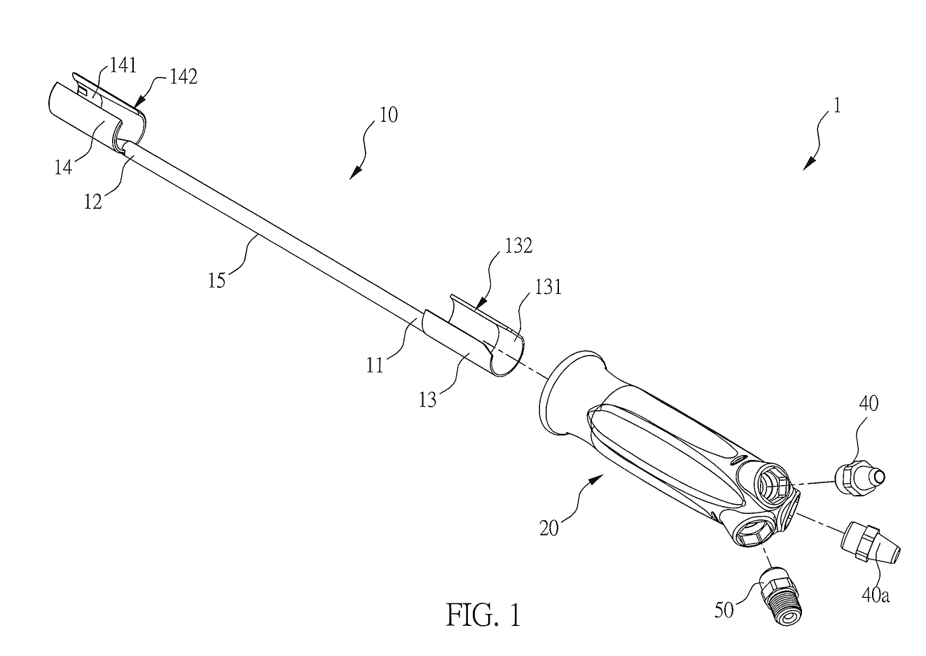

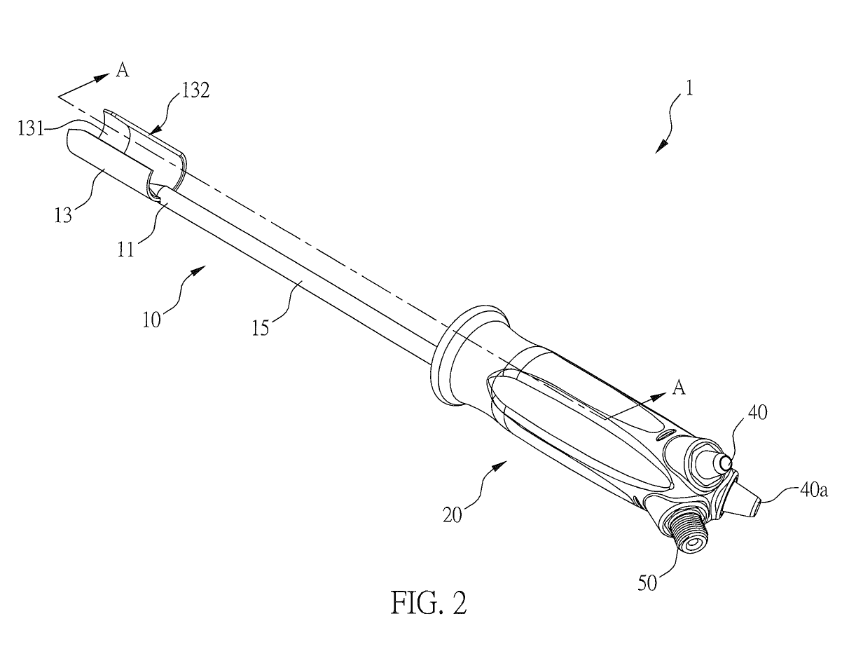

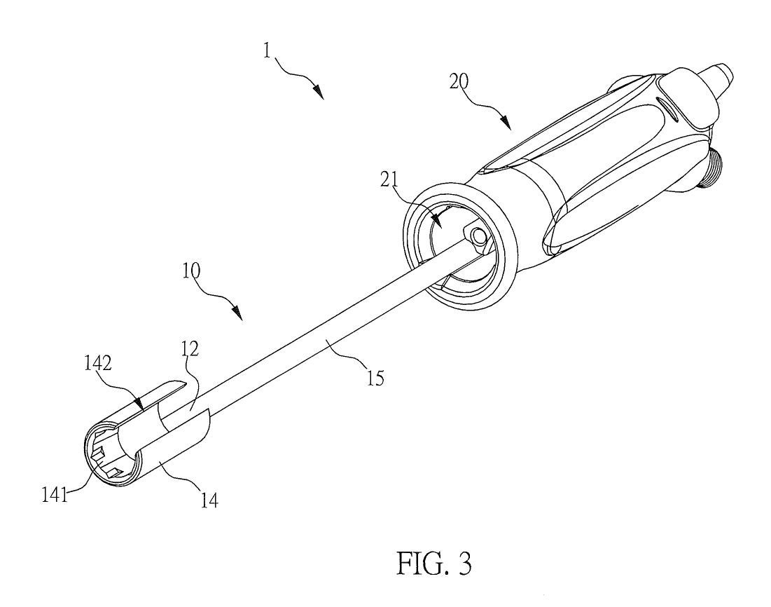

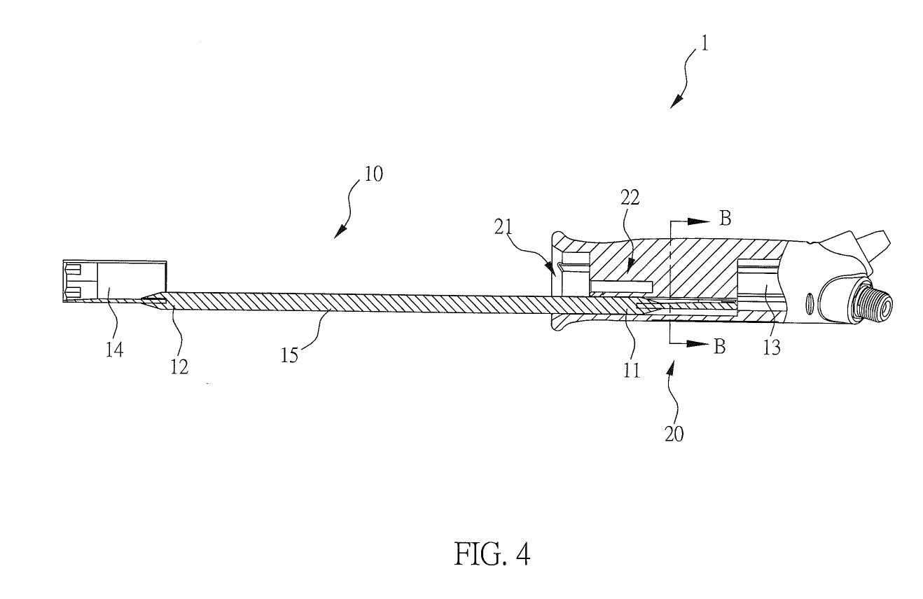

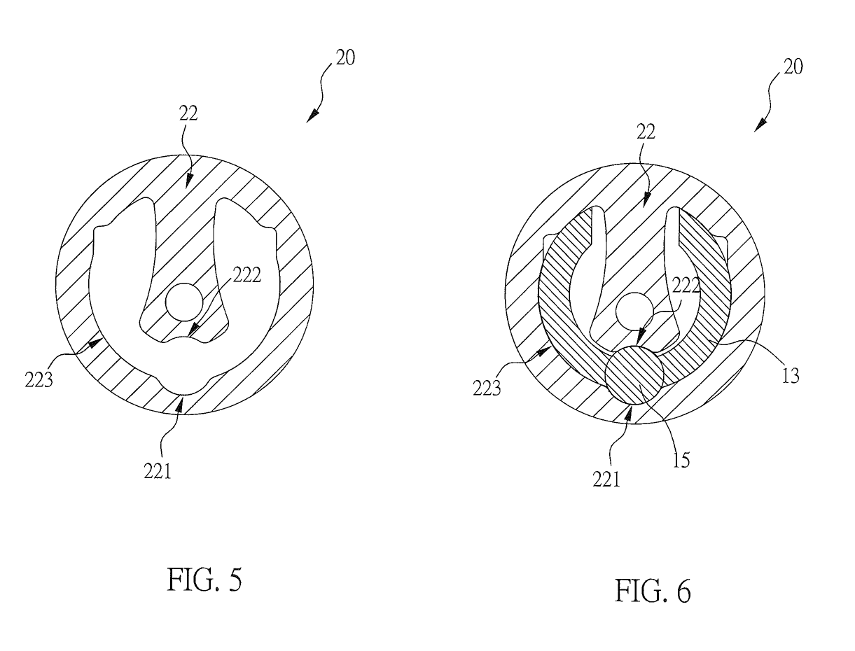

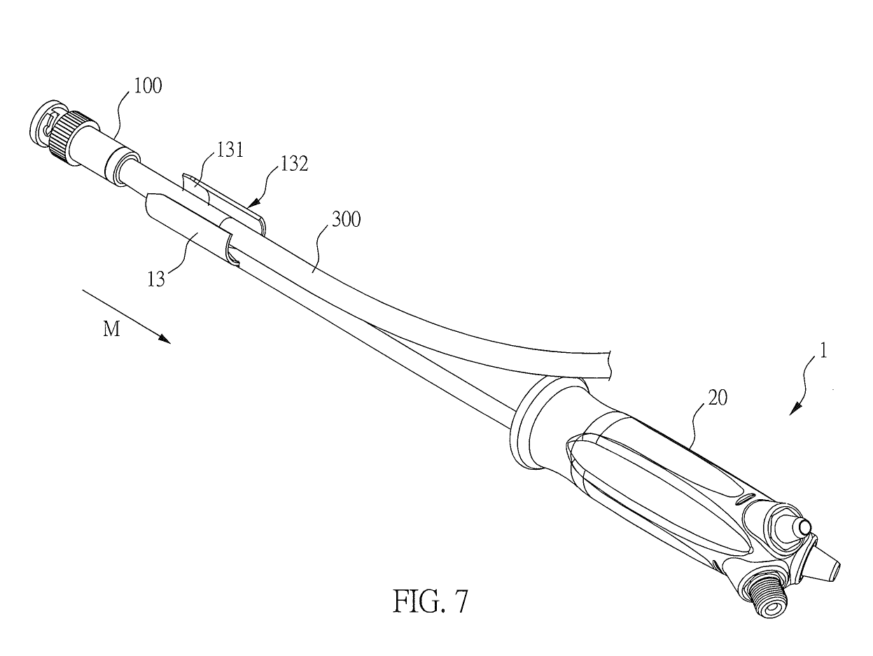

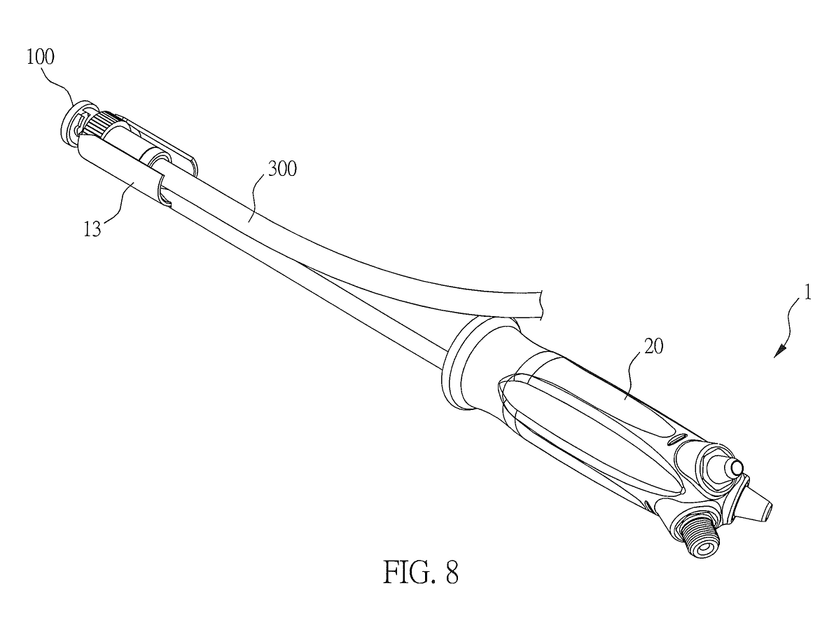

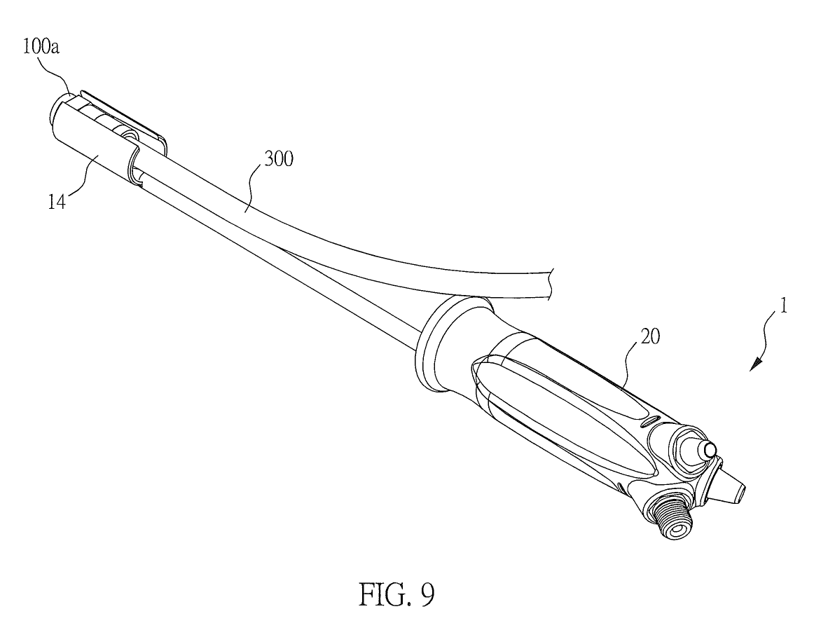

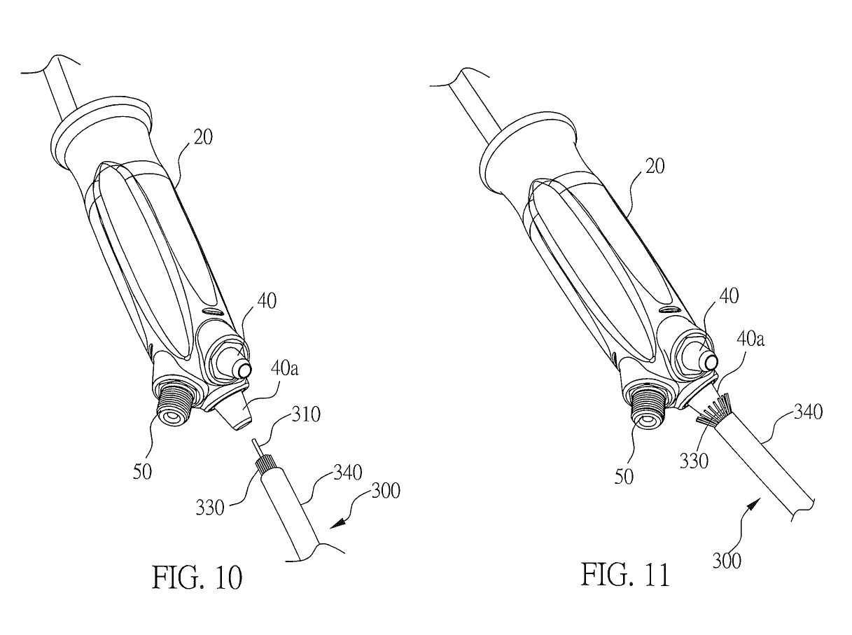

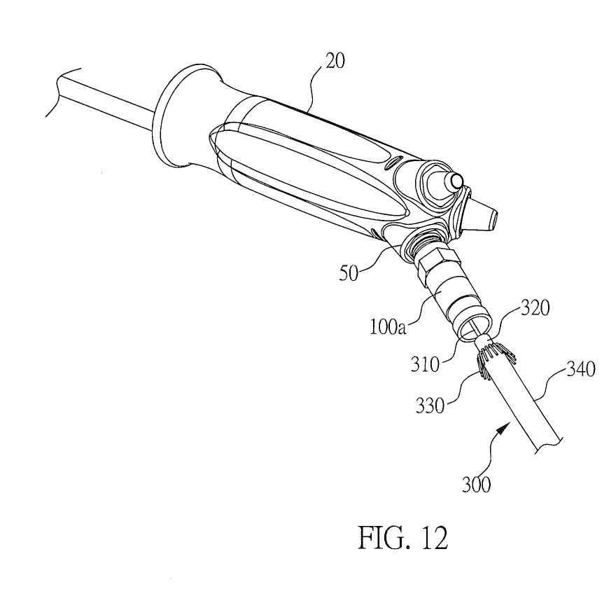

Please refer to FIG. 1 to FIG. 12 about the connector installation and removal tool in one embodiment of the present invention. FIG. 1 illustrates an exploded view of the connector installation and removal tool in one embodiment of the present invention. FIG. 2 illustrates a schematic drawing of the connector installation and removal tool when the second assembly part and the fastening structure are fastened to each other in one embodiment of the present invention. FIG. 3 illustrates a schematic drawing of the connector installation and removal tool when the first assembly part and the fastening structure are fastened to each other in one embodiment of the present invention. FIG. 4 illustrates a sectional view of the connector installation and removal tool in one embodiment of the present invention along the hatch line AA shown in FIG. 2. FIG. 5 illustrates a sectional view of the grip in one embodiment of the present invention along the hatch line BB shown in FIG. 4. FIG. 6 illustrates a sectional view of the fastening structure of the grip when fastened to the first assembly part in one embodiment of the present invention along the hatch line BB shown in FIG. 4. FIG. 7 illustrates a schematic drawing of the connector installation and removal tool, the connector and the wire in one embodiment of the present invention. FIG. 8 illustrates a schematic drawing of the first assembly part of the connector installation and removal tool when fastening to the connector in one embodiment of the present invention. FIG. 9 illustrates a schematic drawing of the second assembly part of the connector installation and removal tool when fastening to the connector in one embodiment of the present invention. FIG. 10 illustrates a schematic drawing of the wire extending unit in one embodiment of the present invention. FIG. 11 illustrates another schematic drawing of the wire extending unit in one embodiment of the present invention. FIG. 12 illustrates a schematic drawing of the connector fastening unit and the wire in one embodiment of the present invention.

As shown in FIG. 7 and FIG. 9, in one embodiment of the present invention, the connector installation and removal tool 1 of the present invention is used for installing or removing two connectors 100, 100a and a wire 300, such as combining the connectors 100, 100a and the wire 300, or installing the connector 100, 100a on an electronic device, or removing the connectors 100, 100a from the electronic device. The connector 100 of the present invention can be a Bayonet Neil-Concelman connector (BNC connector), which has a cylindrical shell and an internal thread structure (not shown in the figure); via the internal thread structure, the connector 100 can be installed on an electronic device, such as a monitor. The connector 100a can be an F connector, which has a hexagonal shell and an internal thread structure (not shown in the figure); via the internal thread structure, the connector 100a can be installed on a television. As shown in FIG. 12, the wire 300 is an audio and video signal cable, such as a coaxial cable; the wire 300 includes a positive core 310, an inner layer 320, a negative layer 330, and an outer layer 340. The outer layer 340 covers the negative layer 330, the negative layer 330 covers the inner layer 320, and the inner layer 320 covers the positive core 310. The negative layer 330 is made of a plurality of resilient metal wires. To combine the wire 300 and the connectors 100, 100a, the user must expose the positive core 310 and the inner layer 320 to the outside, overturn the negative layer 330 outwardly to cover the outer layer 340, make the connectors 100, 100a cover the overturned negative layer 330, and use a crimping tool (such as crimping pliers) to compress the connector 100, 100a and the overturning negative layer 330; then the electronic signal can be transferred normally between the connectors 100, 100a and the wire 300. However, the type and the structure of the connectors 100, 100a and the wire 300 of the embodiment of the present invention are not limited to the above description, for they can be changed according to actual user requirements; furthermore, the structure, the application and the signal transferring theory of the connectors 100, 100a and the wire 300 are disclosed and applied in the field of electronic cables and are not the focus of the present invention, so there is no need for further description.

As shown in FIG. 1 and FIG. 2, in one embodiment of the present invention, the connector installation and removal tool 1 includes an assembly rod 10, a grip 20, two wire extending units 40, 40a, and a connector fastening unit 50.

As shown in FIG. 1 to FIG. 3, and in FIG. 7 and FIG. 9, in one embodiment of the present invention, the assembly rod 10 is used for fastening to the connectors 100, 100a so that the user can install the connectors 100, 100a. The assembly rod 10 includes a first end 11, a second end 12, a first assembly part 13, a second assembly part 14, and a rod body 15. The first end 11 and the second end 12 are respectively located on the two ends of the rod body 15. The first assembly part 13 is located on the first end 11. The second assembly part 14 is located on the second end 12. The first assembly part 13 and the second assembly part 14 both have an arc-shaped outer surface. The first assembly part 13 includes a first connector fastening surface 131 and a first opening 132. The first connector fastening surface 131 is connected to the first opening 132. The first connector fastening surface 131 is an arc-type structure; the shape of the arc-type structure corresponds to the cylindrical shell of the connector 100 for fastening to the connector 100. The first opening 132 is used for allowing the wire 300 to enter. The second assembly part 14 includes a second connector fastening surface 141 and a second opening 142. The second connector fastening surface 141 is connected to the second opening 142. The second connector fastening surface 141 is a multilateral structure; this shape corresponds to the hexagonal shell of the connector 100a for fastening to the connector 100a. The second opening 142 is used for allowing the wire 300 to enter.

As shown in FIG. 3 to FIG. 6, the grip 20 is used for fastening to the assembly rod 10 and is provided for the user to hold, such that the user can conveniently operate the connector installation and removal tool 1. The grip 20 includes a groove 21 and a fastening structure 22. The fastening structure 22 is located in the groove 21, and the fastening structure 22 is used for fastening to the first assembly part 13 or the second assembly part 14. The fastening structure 22 includes a first fastening part 221, a second fastening part 222, and a fastening surface 223. The first fastening part 221 and the second fastening part 222 are arc-shaped notches, and the shape of the notches corresponds to the rod body 15; therefore, the first fastening part 221 and the second fastening part 222 can be fastened to the rod body 15 via a method of close fit. The shape of the fastening surface 223 corresponds to the arc-shaped outer surface of the first assembly part 13 and the second assembly part 14; therefore, the fastening surface 223 can be fastened to the first assembly part 13 or the second assembly part 14 via a method of close fit.

As shown in FIG. 1 and FIG. 2, and FIG. 10 to FIG. 12, in one embodiment of the present invention, the wire extending units 40, 40a are connected to the grip 20. The two wire extending units 40, 40a of the present invention are applied to wires 300 of different sizes. The wire extending units 40, 40a each have a hole and a cone structure. The hole is provided for the positive core 310 to be plugged into. The cone structure is used for expanding the negative layer 330 of the wire 300 so as to separate the negative layer 330 and the inner layer 320. The connector fastening unit 50 is connected to the grip 20. The connector fastening unit 50 has an external thread structure for fastening to the internal thread structure of the connectors 100, 100a. However, the amount of the wire extending units 40, 40a and the connector fastening unit 50 are not limited to the abovementioned description; the amount can be changed according to design requirements.

According to the requirements of the user, the user can fasten the first assembly part 13 or the second assembly part 14 to the fastening structure 22. For example, when the user wants to use the second assembly part 14 to install the connector 100a, as shown in FIG. 4, and in FIG. 6 and FIG. 9, the user can plug the first assembly part 13 into the groove 21; at this moment, the notch of the first fastening part 221 and the second fastening part 222 will fasten the rod body 15 via the method of close fit, and the fastening surface 223 will also be fastened to the arc-shaped outer surface of the first assembly part 13 via the method of close fit. Therefore, the first assembly part 13 can be fastened to the fastening structure 22 stably; thus, the user can easily use the exposed second assembly part 14 to install the connector 100a. Similarly, if the user wants to use the first assembly part 13 for installation, the user can plug the second assembly part 14 into the groove 21 such that the second assembly part 14 can be fastened to the fastening structure 22 stably; therefore, as shown in FIG. 8, the user can easily use the exposing first assembly part 13 for installing the connector.

When the user wants to install a connector 100 and a wire 300 on an electronic device (not shown in the figure), as shown in FIG. 2, the user must combine the assembly rod 10 and the grip 20 and expose the first assembly part 13. Then, as shown in FIG. 7 and FIG. 8, the user can cause the wire 300 to pass through the first opening 132 and pull the wire 300 along the moving direction M to position the connector 100 close to the first connector fastening surface 131. Then the user can apply force continuously to cause the connector 100 to touch the first connector fastening surface 131. At this moment, the arc-type structure of the first connector fastening surface 131 will be fastened to the cylindrical shell of the connector 100; therefore, the connector 100 will be clamped stably by the first assembly part 13, whereby the user can easily hold the grip 20, align the connector 100 which is clamped by the first assembly part 13 with the electronic device, and rotate the grip 20 to install the connector 100 on the electronic device via the internal thread structure. Similarly, when the user wants to install the connector 100a and the wire 300 on the electronic device, as shown in FIG. 3, the user can combine the assembly rod 10 and the grip 20 and expose the second assembly part 14. Then the user can follow the abovementioned operation method to cause the connector 100a to be clamped by the second assembly part 14 (as shown in FIG. 9), such that the user can easily hold the grip 20, align the connector 100a which is clamped by the second assembly part 14 with the electronic device, and rotate the grip 20 to install the connector 100a on the electronic device via the internal thread structure.

When the user wants to use the connector installation and removal tool 1 to combine a wire 300 and a connector 100a, as shown in FIG. 10 to FIG. 12, the user can use a cutting tool (not shown in the figure) to remove the outer layer 340 to expose the positive core 310 and the negative layer 330. Then the user can align the positive core 310 of the wire 300 with the wire extending unit 40a of the corresponding size and plug the positive core 310 into the hole of the wire extending unit 40a. Then the user can push the wire 300 to the wire extending unit 40a; during this process of pushing, the cone structure of the wire extending unit 40a will gradually open the negative layer 330 to cause the negative layer 330 to open outwardly; therefore, the user can easily remove the opening negative layer 330 to expose the inner layer 320 and cause the negative layer 330 to backwardly cover the outer layer 340. Then the user can fasten the connector 100a and the connector fastening unit 50. At this moment, the opening of the hexagonal shell of the connector 100a will be facing toward the outside, whereby the user can easily plug the positive core 310 and the inner layer 320 into the opening of the hexagonal shell of the connector 100a to cause the hexagonal shell of the connector 100a to cover the opening negative layer 330. Finally, the user needs to use only a crimping tool to compress the shell of the connector 100a and the negative layer 330 and thereby combine the wire 300 and the connector 100a with each other smoothly.

Via the design of the connector installation and removal tool 1 of the present invention, the connector installation and removal tool 1 can install connectors 100, 100a of different specifications and remove the negative layer 330 of the wire 300 to combine the wire 300 and the connectors 100, 100a with each other.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the spirit and scope of the invention.

What is claimed is:

1. A connector installation and removal tool, comprising:
an assembly rod, comprising:
a first end;
a second end;
a first assembly part, located on the first end; and
a second assembly part, located on the second end;
a grip, comprising:
a groove; and
a fastening structure, located in the groove, wherein the fastening structure is used for fastening to the first assembly part or the second assembly part.

2. The connector installation and removal tool as claimed in claim 1, wherein the assembly rod further comprises a rod body, the fastening structure further comprises a first fastening part and a second fastening part, and the first fastening part and the second fastening part are used for fastening to the rod body.

3. The connector installation and removal tool as claimed in claim 2, wherein the fastening structure further comprises a fastening surface, and the fastening surface is used for fastening to the first assembly part or the second assembly part.

4. The connector installation and removal tool as claimed in claim 3, further comprising a wire extending unit, wherein the wire extending unit is connected to the grip.

5. The connector installation and removal tool as claimed in claim 3, further comprising a connector fastening unit, wherein the connector fastening unit is connected to the grip.

6. The connector installation and removal tool as claimed in claim 4, wherein the first assembly part further comprises a first connector fastening surface and a first opening, and the first connector fastening surface is connected to the first opening.

7. The connector installation and removal tool as claimed in claim 5, wherein the first assembly part further comprises a first connector fastening surface and a first opening, and the first connector fastening surface is connected to the first opening.

8. The connector installation and removal tool as claimed in claim 6, wherein the first connector fastening surface is an arc-type structure.

9. The connector installation and removal tool as claimed in claim 8, wherein the second assembly part further comprises a second connector fastening surface and a second opening, and the second connector fastening surface is connected to the second opening.

10. The connector installation and removal tool as claimed in claim 9, wherein the second connector fastening surface is a multilateral structure.
